(19) United States
(12) Patent Application Publication
(10) Pub. No.: US 2005/0282003 A1
(43) Pub. Date: Dec. 22, 2005

(54) Coated article and process for coating article with anticorrosive finish

(76) Inventors: Alexander Mayzel, Highland Heights, OH (US); John D. Vacarchuk, Medina, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/871,771

(22) Filed: Jun. 18, 2004

(51) Int. Cl. B32B 15/08; B32B 27/30

(52) U.S. Cl. 428/336; 428/457; 428/626; 428/522

(57) ABSTRACT

A multi-layer coating having a polished effect for the surface of an article, the multi-layer coating including a cured polymeric layer overlying the surface of the article; a metal layer on the polymeric layer, the metal layer including (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel; and a transparent top coat layer overlying the metal layer, and a process for applying the multi-layer coating.

### TECHNICAL FIELD

The present invention relates to a coated article and a process for providing durable multi-layer coating systems for manufacturing goods with a high quality bright “chrome-like” surface. More particularly, the present invention provides a coated article and a process for coating the article using vacuum metallization. The present invention further relates to finishes that exhibit anticorrosive properties and produce the appearance of polished metals.

### BACKGROUND

Historically, electroplating was used to produce corrosive resistant coating over polished metal goods. This method of finishing includes expensive and environmentally hazardous stages of polishing and multi-layer electroplating. More recently a process of vacuum metallization became a popular method of producing appearance of chrome plating or a polished metal surface.

U.S. Pat. No. 6,399,152 describes a process of coating a substrate with a chrome finish that comprises (a) cleaning and preparation of the surface of the substrate, (b) applying a base coat to the said substrate and baking it at 229-246° C., (c) applying a first metal layer containing a mixture of nickel and chrome by a vacuum deposition process on top of the base coat, (d) applying a second metal layer of pure chrome using a vacuum deposition process on top of the first metal layer, and (e) applying a top coat over the second metal layer.

The process disclosed in U.S. Pat. No. 6,399,152 has several shortcomings. First, curing of the base coat requires an approximate temperature range of 229-246° C. Many substrates, especially substrates made of or comprising aluminum and magnesium alloys, cannot withstand such temperatures without undergoing artificial aging, which may involve loss of temper, metal strength and/or durability, and make the metal article subject to catastrophic failure. Second, the two different metal layers (one nickel-chrome and second pure chrome) produce a galvanic cell that would promote corrosion if the layers are scratched or otherwise damaged.

Thus, a need remains for an anticorrosive coating which provides a smooth, shiny, corrosion-resistant finish that is also resistant to environmental damage during its normal use.

### SUMMARY

The present invention overcomes drawbacks of the prior art and avoids the problems inherent in the method and article of U.S. Pat. No. 6,399,152. The process of the present invention avoids exposing the substrate to high temperatures and greatly improves corrosion resistance of the finish. The finish of the present invention can be used over substrates made of all kinds of metals and alloys as well as ceramics and certain plastics. Articles to which embodiments of the present invention may be applicable include, for example, metal articles such as automotive and motorcycle wheels, parts and accessories, and the like. In addition, articles to which embodiments of the present invention may be applicable include polymeric, glass and ceramic articles, with and without metallic surfaces.

In one embodiment, the present invention relates to a multi-layer coating having a polished effect for the surface of an article, the multi-layer coating including a cured polymeric layer overlying the surface of the article; a metal layer on the polymeric layer, the metal layer including (a) aluminum or an aluminum alloy and (b) at least one alloying element, in which the at least one alloying element includes one or more of chromium, nickel, titanium, zinc, manganese, iron, cobalt, zirconium, carbon, silicon, molybdenum, vanadium and stainless steel; and a transparent top coat layer overlying the metal layer. In one embodiment, the article is a metal article and includes a corrosion inhibiting conversion coating on the surface of the article and the cured polymeric layer is on the conversion coating. In one embodiment, a second corrosion inhibiting conversion coating is applied on the metal layer.

In another embodiment, the present invention relates to a process for providing a multi-layer coating on a surface of an article, including providing an article having a surface; applying a layer of curable polymer over the surface of the article; curing the curable polymer; applying a metal layer on the polymer layer, the metal layer including (a) aluminum or an aluminum alloy and (b) at least one alloying element, in which the at least one alloying element comprises one or more of chromium, nickel, titanium, zinc, manganese, iron, cobalt, zirconium, carbon, silicon, molybdenum, vanadium and stainless steel; and applying a transparent top coat layer over the metal layer. In one embodiment, in which the article is a metal article, the process further includes applying a corrosion inhibiting conversion coating on the surface of the article, and the cured polymeric layer is applied over the conversion coating. In one embodiment, a second corrosion inhibiting conversion coating is applied on the metal layer.

The present inventors discovered that an unexpectedly strong bond is formed between the aluminum of the metal layer and the curable polymer over which it is applied, resulting in improved performance and extended useful lifetime of the article, and addition of the alloying metal provides control of various characteristics of the metal layer including, in particular, its color, stone chip resistance, adhesion, and/or corrosion resistance.

Thus, the present invention addresses the problems in the prior art relating to applying such finishes to various articles.

### BRIEF DESCRIPTION OF THE DRAWING

FIG. 1 is a schematic cross-sectional view of a substrate coated with a multi-layer coating in accordance with an embodiment of the present invention.

FIG. 2 is a schematic cross-sectional view of a substrate coated with a multi-layer coating in accordance with another embodiment of the present invention.

FIG. 3 is a schematic cross-sectional view of a substrate coated with a multi-layer coating in accordance with yet another embodiment of the present invention.

FIG. 4 is a schematic cross-sectional view of a substrate coated with a multi-layer coating in accordance with still another embodiment of the present invention.

FIG. 5 is a schematic process flow diagram illustrating a process for applying a substrate with a multi-layer coating to a substrate in accordance with various embodiments of the present invention.

It should be appreciated that for simplicity and clarity of illustration, elements shown in the Figure have not necessarily been drawn to scale. For example, the dimensions of some of the elements may be exaggerated relative to each other for clarity. Further, where considered appropriate, reference numerals have been repeated among the Figures to indicate corresponding elements.

### DETAILED DESCRIPTION

It should be appreciated that the process steps and structures described below may not form a complete process flow for manufacturing a product having the disclosed anticorrosive finish, such as an automobile wheel. The present invention can be practiced in conjunction with manufacturing techniques currently used in the art, and only so much of the commonly practiced process steps are included as are necessary for an understanding of the present invention.

In one embodiment, the present invention relates to a multi-layer coating having a polished effect for the surface of an article. In accordance with some embodiments of the present invention, articles such as automobile or motorcycle parts, and any other suitable parts, to which a shiny “chrome-plate-like” finish is desired to be applied, can be formed without the environmental problems associated with chrome electroplating and without the danger of overheating and adversely affecting the properties of metal articles such as cast or forged aluminum parts. In other embodiments, the substrate may be or include glass, ceramic or polymeric materials, and in some embodiments, such materials may include metal surfaces. For example, plastic or glass substrates may include metallized surfaces, to which embodiments of the present invention may be applicable.

In one embodiment, the multi-layer coating includes a cured polymeric layer overlying the surface of the article; a metal layer on the polymeric layer, the metal layer comprising (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel; and a transparent top coat layer overlying the metal layer.

In one embodiment, in which the article is a metal article, a corrosion inhibiting conversion coating may be applied to the metal surface of the article. In this embodiment, the cured polymeric layer is applied over the conversion coating.

In one embodiment, the corrosion inhibiting conversion coating may be selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium. The conversion coating may be applied by any suitable method known in the art. In general, the conversion coating may be applied to the metal surface of the article by spraying, dipping or otherwise coating onto the metal surface a solution of a salt or oxide of the selected metal. The solution may be, for example, aqueous, and may contain suitable additives such as surfactants, solubilizing agents, etc., as known in the art for use with solutions used for applying conversion coatings to substrates.

In one embodiment, the curable polymer used to form the cured polymeric layer may include one or more of a monofunctional, bi-functional or multi-functional acrylic polymer or copolymer. As used herein, an acrylic polymer includes polymers and copolymers of one or more of acrylic acid, methacrylic acid, ethylacrylic acid, higher alkyl acrylic acids and C₁-C₁₂ esters thereof. Of the acrylic esters, useful alkyl acrylates include, for example, methyl, ethyl, n-propyl, isopropyl, n-butyl, 2-ethyl hexyl, isooctyl acrylate, and the like. The curable polymer may include bi-functional or multi-functional acrylates.

Thus, in an embodiment in which the cured polymer is an acrylic polymer, in one embodiment, it may include a polymer or copolymer including monomeric units derived from one or more compounds of the general formula (I): 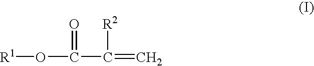
wherein in formula (I),

R¹ may be H, C₁-C₁₂ alkyl, a bi-functional group including glycidyl and higher epoxidized alkyl groups, hydroxyalkyl (e.g., C₁-C₁₂ alkyl), etc., a multi-functional group including two or more of the foregoing functional groups or additional acrylic moieties, and

R² may be C₁-C₁₂ alkyl.

In other embodiments, the curable polymer may further comprise one or more diacrylate and di(meth/eth)acrylate esters, tri- or higher acrylate and (alk)acrylate esters, of aliphatic, cycloaliphatic or aromatic diols, including 1,3- or 1,4-butanediol, neopentyl glycol, 1,6-hexanediol, diethylene glycol, triethylene glycol, tetraethylene glycol, polyethylene glycol, tripropylene glycol, ethoxylated or propoxylated neopentyl glycol, 1,4-dihydroxymethylcyclohexane, 2,2-bis(4-hydroxycyclohexyl)propane, bis(4-hydroxycyclohexyl)methane, and similar diols. Thus, in one embodiment, the bi- or multi-functional acrylate has a general formula (II): 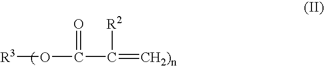
wherein in formula (II)

R² represents the same groups as defined above,

R³ represents a bi- or multivalent alkyl, cycloalkyl or aromatic residue, and

n is an integer of 2 or more, corresponding to the valency of the R³ residue.

R³ may be, for example, an n-valent aliphatic hydrocarbon, an n-valent ether or polyether radical, an n-valent substituted ether or polyether radical, an n-valent olefinically unsaturated hydrocarbon radical, or an n-valent aromatic substituted or unsubstituted hydrocarbon radical. Suitable R³ substituents and bi- or multi-functional acrylates can be selected by those of skill in the art based on the expected environment of use of the finished article. In one embodiment, the bi- or multi-functional acrylic polymer may include one or more of polyethylene glycol diacrylate, pentaerythritol diacrylate, trimethylolpropane tri(meth)acrylate, dipentaerythritol pentaacrylate, dipentaerythritol hexaaacrylate or pyrrogallol triacrylate.

In one embodiment, the acrylic polymer comprises a glycidyl (meth/eth)acrylate.

The curable polymer or copolymer composition may be applied as a powder or as a liquid coating, or by any other suitable method known in the art for applying such layer, followed by appropriate curing. The curable polymer or copolymer composition may include suitable known additives.

In one embodiment, multi-layer coating further includes a cured polymeric primer layer on the surface of the article, which is overlain by the cured polymeric layer. The primer layer may be applied to the surface of the article to improve adhesion between the surface and the subsequently applied cured polymeric layer. In one embodiment, the cured polymeric primer layer includes a polymer the same as or different from the cured polymeric layer. Thus, in one embodiment, the primer layer includes a cured polymer that is different from the cured polymer layer to which the metal layer will be applied. In some embodiments, it may be useful to include a primer layer of a cured polymer selected for its ability to adhere strongly to the surface of the article, to which a subsequently applied cured primer layer, selected for its adhesion or preferred bonding to the overlaying metal layer, can be applied. In another embodiment, the primer layer may comprise substantially the same cured polymer, but the primer layer may be applied by a different method or under different conditions optimized for adhesion to the surface of the article. In such an embodiment, the cured polymer can be suitably selected for its adhesion or preferred bonding to the overlaying metal layer.

In one embodiment, the cured polymeric primer layer may comprise any one or more of the above-described cured polymeric layer materials. In another embodiment, the cured primer layer may comprises any material known and selected for use as a primer layer material between the surface of the article and the overlying cured polymeric layer.

As described herein, the metal layer is applied to the curable polymeric layer. In one embodiment, the metal layer includes from about 50 to about 95 wt % aluminum, based on the total weight of the metal layer. In another embodiment, the metal layer includes from about 60 to about 90 wt % aluminum. In another embodiment, the metal layer includes from about 65 to about 85 wt % aluminum. The remainder of the metal layer includes one or more alloying metals. The one or more alloying metals may be any of the metals listed above for (b) or any of the metals contained in the aluminum alloy in (a). The aluminum alloys in (a) may includes any of the many known aluminum alloys. Aluminum is commonly alloyed with metals such as copper (Cu), manganese (Mn), silicon (Si), magnesium (Mg), and zinc (Zn), and various combination of these and other metals, including iron (Fe), lithium (Li), nickel (Ni) and tin (Sn), among others. Aluminum alloys generally include from 0.1 up to about 13 wt % of the alloying metal(s). In contrast, in one embodiment, the metal layer of the present invention includes from about 15 to about 40 wt % of the alloying metal, and in one embodiment from about 5 wt % to about 50 wt %. The amounts may vary, depending on the exact alloying metal. In some embodiments of the present invention, higher levels of aluminum may be used depending, for example, on the specific alloying metal used and on the desired properties of the metal layer.

Here and elsewhere in the specification and claims, the limits of the disclosed ranges and ratios may be combined. Thus, in the foregoing ranges of aluminum, although not specifically recited, a range of about 50 wt % to about 90 wt % is included within the scope of the disclosure.

In one embodiment, the top coat layer comprises one or more of an organic coating, a ceramic coating or an organopolysiloxane coating. The top coat layer may be an organic, ceramic, or an organically modified ceramic transparent coating. The top coat layer may be applied using liquid spray, powder spray, electro-coat or dip methods.

In one embodiment, the top coat layer may be an ormocer. As known in the art, an ormocer typically comprises a polar component, a hydrophobic component and micro-ceramic particles. The polar component provides good adhesion of the ormocer to the underlying layer. The hydrophobic component, which may be a fluorinated material, is preferably orientated to the air-coating interface so as to impart non-stick properties at the coating surface. The micro-ceramic particles impart abrasion resistance and anti-scratch properties. In one embodiment, the ormocer includes a metal oxide-polymeric coating, for example, a ZrO₂-polymethylmethacrylate coating. Other known ormocers may be used. In one embodiment, the top coating is an organopolysiloxane coating, which is another example of an ormocer.

Suitable organopolysiloxane compositions are known in the art for use in protective layers such as the top coat of the present invention.

In one embodiment, the top coat layer comprises a second cured polymeric coating which may be the same or different from the cured polymeric layer overlying the corrosion inhibiting conversion coating.

In one embodiment, the multi-layer coating further includes a second corrosion inhibiting conversion coating on the metal layer. In one embodiment, the second corrosion inhibiting conversion coating may be any of the conversion coating materials described above with respect to the conversion coating which may be applied to the metal surface of the article, in an embodiment in which the article comprises a metal surface.

In one embodiment, the metal layer is an atomized metal layer. The atomized metal layer may be applied by any known method, such as CVD, PVD, In one embodiment, the metal layer has a thickness from about 0.5 to about 3 microns. In another embodiment, the metal layer has a thickness from about 1 to about 2.5 microns, and in another, from about 1 to about 1.5 microns.

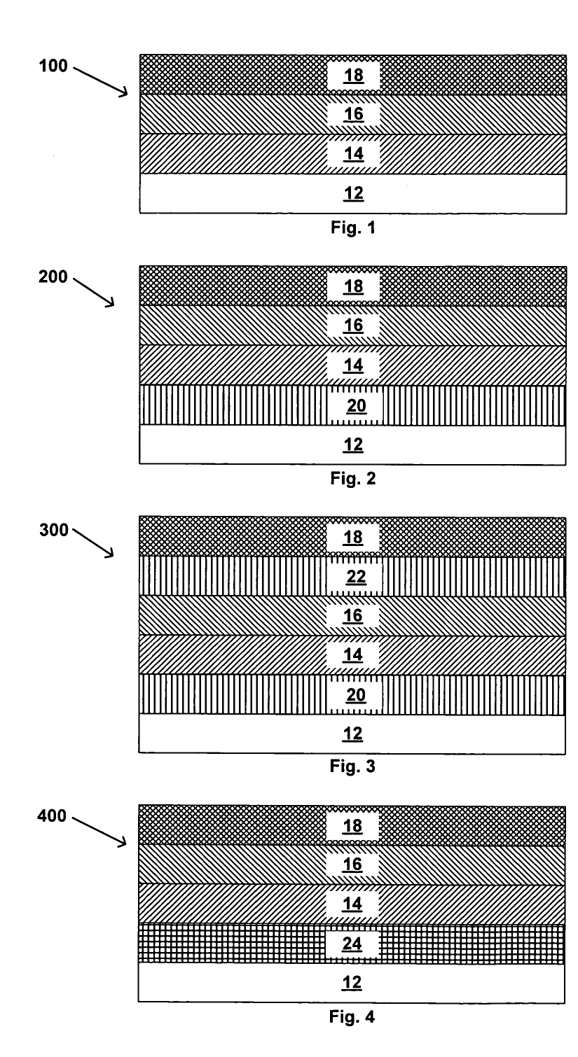

Referring to FIG. 1, a process for forming an article 100 having a multi-layer coating in accordance with one embodiment of the invention is described. The article 100 includes a manufacturing good or substrate 12 which can be made of a metal, metal alloy, glass, plastic or ceramic. The substrate 12 may be, for example, an automobile part, such as an aluminum alloy wheel.

In one embodiment, a polymeric layer 14 is applied over the surface of the article 12. The polymeric layer 14, in one embodiment is a cured polymeric coating or layer. The polymeric layer 14 can be applied as a powder or liquid, and may be applied by any appropriate method. The cured polymeric layer 14 may be any of the cured polymers described above.

The polymeric layer 14 may have at least two purposes. First, the polymeric layer 14 can level and smooth the surface of the substrate and can hide surface defects, scratches, etc. For that reason, in one embodiment, the polymeric layer 14 may be applied to produce a very smooth coating and to fill in surface irregularities. To produce a high quality finish, the surface of the polymeric layer 14 should have no long wave “orange peel” texture and should have no short wave texturing that would telegraph or propagate through the rest of the finish layers and be visible at the surface. Second, the polymeric layer 14 can serve as a substrate for the subsequent application of the metal layer, in the metallization step. As noted above, the present inventor discovered that the cured polymeric layer 14 provides an unexpectedly strong bond with the aluminum of the subsequently applied metal layer.

In one embodiment, after it is applied, the curable polymeric layer 14 is baked for a period ranging from about 0.5 to about 1.5 hours at an oven temperature, in one embodiment, in the range from about 350 to about 380° F. (about 175° C. to about 195° C.), in order to cure the polymer. This bake can be accomplished in any standard oven, such as a conversion or IR oven. The oven temperature is a set point temperature, not necessarily the temperature of the article.

Referring still to FIG. 1, the next layer of the finish is a metal layer 16. In one embodiment, the metal layer 16 is relatively thin, and may be applied in vacuum onto the heated polymeric layer 14 at surface temperature between about 180 and about 360° F. (about 80° C. to about 185° C.). The metal layer 16 may be applied using sputtering, PVD, CVD, or thermal evaporation by simultaneous treatment and deposition of at least two different metals or alloys one of those being aluminum or aluminum alloy. In one embodiment, the metal layer includes (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel.

In one embodiment, a top coating 18 is applied over the metal layer 16. The top coating 18 provides protection from scratching and abrasion to the underlying metal layer 16, the cured polymer layer 14 and the substrate 12. The topcoat may be an organic, ceramic, or organopolysiloxane coating applied using liquid spray, powder spray, electro-coat or dip methods. As noted above, in one embodiment, the top coating 18 may be a cured polymeric layer such as the cured polymeric layer 14, and the polymer may be independently selected from the same polymers useful for the layer 14.

Referring now to FIG. 2, an article 200 in accordance with another embodiment of the present invention is described. In this embodiment, the substrate 12 is a metal or metal alloy or in another material having a metallic surface. In this embodiment, a first layer 20 of an anticorrosive finish, such as an inorganic conversion coating, is applied to the surface of the metal or metal alloy article 12.

Examples of this conversion coating include oxides or salts of one or more of Al, Cd, Co, Cs, Cu, Mn, Mo, Ni, Si, Ti, Zn, Zr. The conversion coating can be applied, e.g., from an aqueous solution of an appropriate salt or oxide. Application of the conversion coating results in sedimentation or deposition of salts or oxides of the selected one or more metal in the layer 20 on the surface of the substrate 12. The conversion coating also contains some amount of salt and/or oxide of the substrate metal. This layer provides protection to the substrate from corrosion attack and promotes adhesion between the substrate and the next overlying layer, the polymeric layer 14.

Application of the remaining layers shown in FIG. 2, that is, the polymeric layer 14, the metal layer 16 and the top coating 18, are substantially the same as in the embodiment illustrated in FIG. 1, and are not repeated.

Referring now to FIG. 3, an article 300 in accordance with another embodiment of the present invention is described. In this embodiment, the substrate 12 is a metal or metal alloy or in another material having a metallic surface. In this embodiment, a first layer 20 of an anticorrosive finish, such as an inorganic conversion coating, is applied to the surface of the metal or metal alloy article 12. The cured polymeric layer 14 and the metal layer 16 are applied over the conversion coating 20, as described above with respect to the embodiment illustrated in FIG. 2. In the embodiment illustrated in FIG. 3, an additional conversion coating 22 is applied to the metal layer 16. The additional conversion coating 22 may include any of the materials described herein with respect to the conversion coating 20, and the material used for the additional conversion coating 22 may be selected independently of the materials used for the conversion coating 20.

Application of the remaining layers shown in FIG. 3, that is, the polymeric layer 14, the metal layer 16 and the top coating 18, are substantially the same as in the embodiment illustrated in FIGS. 1 and 2, and are not repeated.

FIG. 4 shows an embodiment 400 of the present invention similar to the embodiment of FIG. 1, in which a cured polymeric primer layer 24 has been applied to the surface of the article 12 prior to application of the cured polymeric layer 14. The remaining layers of FIG. 4 are substantially the same as shown and described with respect to FIG. 1, and are not separately described. The cured primer layer may be applied to other embodiments, such as those shown in FIGS. 2 and 3, to similar effect as described herein, that is, the cured polymeric layer 14 will be applied to the cured polymeric primer layer 24. Thus, for example, if the cured polymeric primer layer 24 is applied to the embodiment 200 or 300 shown in FIGS. 2 and 3, respectively, except that the cured primer layer 24 would be applied over the first conversion coating layer 20, and will be overlain by the cured polymeric layer 14.

Processes

In one embodiment, the present invention relates to a process for providing a multi-layer coating on a surface of an article, including providing an article having a surface; applying a layer of curable polymer over the surface of the article; curing the curable polymer; applying a metal layer on the polymer layer, the metal layer comprising (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel; and applying a transparent top coat layer over the metal layer.

In one embodiment, in which the article is a metallic article, the process further includes applying a corrosion inhibiting conversion coating to the surface of the metallic article. The conversion coating may be any of those described above.

In one embodiment, the process further includes applying a second corrosion inhibiting conversion coating on the metal layer. The conversion coating may be any of those described above.

In one embodiment, the metal layer is applied by atomizing the aluminum or aluminum alloy and the at least one alloying element.

In one embodiment, the aluminum or aluminum alloy and the at least one alloying element are atomized substantially simultaneously.

In one embodiment, the atomizing is sputtering, CVD, PVD or thermal evaporation.

In one embodiment, the metal layer is applied to a thickness from about 0.5 to about 3 microns, and in another embodiment, from about 1 to about 2.5 microns and in another from about 1 to about 1.5 microns.

In one embodiment, the curable polymer is applied as a powder coating and is baked at an oven temperature in the range from about 175° C. to about 195° C. In another embodiment, the temperature is in the range from about 180° C. to about 190° C.

In one embodiment, the coating is baked for a time ranging from about 0.5 to about 1.5 hours. In another embodiment, the baking time ranges from about 0.75 hours to about 1.25 hours.

In one embodiment, the process further includes applying a primer layer of curable polymer to the surface of the article prior to the applying a layer of curable polymer over the surface of the article. As described above, the primer layer may comprise a polymer the same as or different from the layer of curable polymer, and may be selected as appropriate to the material of the article and the identity of the overlying curable polymer and/or the metal layer.

In one embodiment, the metal layer is applied in vacuum onto the polymeric coating at a temperature in the range from about 80° C. to about 185° C. In another embodiment, the temperature is in the range from about 82° C. to about 182° C.

In one embodiment, the atomizing is carried out in a plasma in the presence of argon or a mixture of argon and one or more of nitrogen, oxygen and a carbon-containing gas. In one embodiment, the carbon-containing gas comprises one or more of a C₁-C₄ alkane, alkene or alkyne. The presence of such mixtures allows for formation of nitrides, oxides and/or carbides of the aluminum and/or the alloying metal from the gas in addition to the argon.

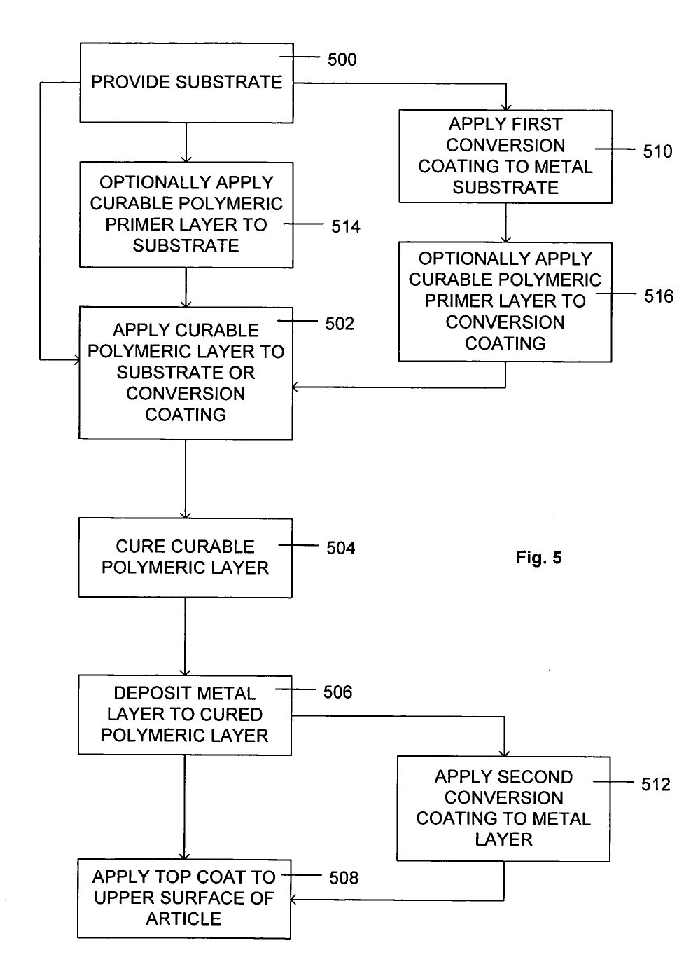

Referring now to FIG. 5, various embodiments of a process in accordance with the present invention are described. FIG. 5 is a schematic process flow diagram illustrating a process for coating a substrate with an anticorrosive finish in accordance with various embodiments of the present invention.

As shown in FIG. 5, in one embodiment, the process includes a first step 500, in which a suitable substrate, as described above, is provided, onto which the multi-layer coating in accordance with an embodiment of the present invention will be applied.

In the next step 502, a curable polymeric layer is applied to the surface of the substrate. The curable polymeric layer may be any of those described above. In one embodiment, the curable polymer (or copolymer) is one or more of a monofunctional, a bifunctional or a multi-functional acrylic.

In the next step 504, the curable polymeric layer is cured, for example by application of heat or by irradiation with visible, UV, IR or electron beam radiation.

In the next step 506, a metal layer is deposited to the cured polymeric layer. The metal layer includes (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel. In one embodiment, the metal is applied by atomizing, for example, by CVD, PVD, sputtering or thermal evaporation.

In the next step 508, a top coat layer is applied to the upper surface of the article. In one embodiment, the top coat layer is applied over the metal layer. In another embodiment, the top coat layer is applied directly to the metal layer.

As shown in FIG. 5, in one alternative embodiment, in which the substrate or article is metal or has a metallic surface, in a step 510, a conversion coating may be applied to the metallic surface of the substrate or article. As shown in FIG. 5, in this embodiment, the step 510 is carried out prior to the step 502, so that the curable polymer layer is applied to or over the conversion coating.

As shown in FIG. 5, in another alternative embodiment, in a step 512, a second conversion coating is applied to the metal layer deposited in step 506. In this embodiment, the second conversion coating provides corrosion protection to the metal layer. In one embodiment, the second conversion coating provides corrosion protection to both sides of the metal layer, even though it is only applied to one side thereof. The step 512 may be applied to the metal layer irrespective of whether a first conversion coating is applied to the surface of the substrate or article as described for the step 510. Conversely, the step 510 may be applied to the metallic surface of the metal article irrespective of whether a second conversion coating is applied to the metal layer as described for the step 512. In one embodiment, both the first conversion coating and the second conversion coating are applied, so that both steps 510 and 512 are carried out, in addition to the steps 500, 502, 504, 506 and 508.

As shown in FIG. 5, in one embodiment, the process includes a step 514, in which a curable polymeric primer layer is applied to the surface of the article. The primer layer has been described hereinabove. In this embodiment, the cured polymeric primer layer may improve adhesion between the surface of the article and the overlying cured polymeric layer, which is applied subsequently in the step 502.

As shown in FIG. 5, in another embodiment, the process includes a step 516, in which a curable polymeric primer layer is applied to the first conversion coating which was applied in the step 510. The primer layer has been described hereinabove. In this embodiment, the cured polymeric primer layer may improve adhesion between the surface of the first conversion coating and the overlying cured polymeric layer, which is applied subsequently in the step 502.

The following examples are intended to illustrate the invention, and are not intended to be limiting of the scope of the invention, which is only limited by the full scope of the claims appended hereto.

### Example 1

A cast aluminum automotive wheel rim is coated with a multi-layer coating in accordance with an embodiment of the present invention. A cobalt based conversion coating is applied onto the surface of the rim. After drying, the rim is powder coated with clear glycidyl acrylic powder coating and the coating is baked for 20 minutes at about 185° C. to produce a smooth surface. The coating is baked for an additional 60 minutes at about 188° C. The rim is then transferred to a suitable vacuum chamber for metallization. The metallization process is started when the surface temperature of the rim is between about 154° C. and about 177° C. In this example, the metallization uses two metals, pure aluminum and stainless steel, which are sputtered simultaneously to obtain an alloy of aluminum and stainless steel. The ratio of the alloy is about 75-80% aluminum and about 25-20% stainless steel. The metallization continues for about 200 seconds, which is sufficient to produce a bright chrome-looking metal layer with a bluish undertone having a thickness of approximately 1 to 1.5 microns. Next, a glycidyl acrylic powder clear topcoat is applied over the rim and baked in an oven for about 20 minutes at about 185° C.

The finished rim is very shiny and has a smooth surface that resembles a coating produced by chrome electroplating.

The finished rim passes the cross-hatch adhesion test with no loss of adhesion, passes the gravelometer test with no chipping off of the finish from the substrate, after 1000 hours the neutral salt spray corrosion test shows less than 3 mm damage from the cut, and in the CASS corrosion test after 168 hours shows less than 3 mm adhesion loss from the cut.

### Example 2

A multi-layer coating in accordance with another embodiment of the present invention is applied onto the surface a forged aluminum automotive wheel in this example. The forged aluminum wheel is provided. A cobalt based conversion coating is applied onto the surface of the rim. After drying, the rim is powder coated with black glycidyl acrylic powder coating and the coating is baked for 90 minutes at about 191° C. to produce a smooth surface. The rim is then transferred to a suitable vacuum chamber for metallization. The metallization process is started when the surface temperature of the rim is between about 121 and 138° C. In this example, the metallization is performed by simultaneously sputtering two metals, pure aluminum and pure chromium, for a period of about 140 sec. The ratio of deposition is about 75-85% aluminum and about 25-15% chromium. The resulting coating has a bright chrome-looking metallic appearance having a thickness of about 0.5 to 1.5 microns. The color of this finish is darker than that in Example 1. Next, a powder clear glycidyl acrylic topcoat is applied over the rim and baked in an oven for about 20 minutes at about 185° C.

The finished rim passes the cross-hatch adhesion test with no loss of adhesion, passes the gravelometer test with no chipping off of the finish from the substrate, after 1000 hours the neutral salt spray corrosion test shows less than 3 mm damage from the cut, and in the CASS corrosion test after 168 hours shows less than 3 mm adhesion loss from the cut.

The CASS test is the Copper Accelerated Salt Spray Test, which is an accelerated corrosion test, substantially in accordance with ASTM B368.

The gravelometer test is designed to evaluate the resistance of surface coatings (paint, clear coats, metallic plating, etc.) to chipping caused by the impacts of gravel or other flying objects, substantially in accordance with ASTM D3170 and SAE J400. The primary usage of this test is to simulate the effects of the impact of gravel or other debris on automotive parts.

The cross-hatch adhesion test is a standard test for determining the adhesion of coatings to substrates, substantially in accordance with ASTM D3359.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention, which is limited only by the scope of the appended claims.

1. A multi-layer coating having a polished effect for the surface of an article, the multi-layer coating comprising:
a cured polymeric layer overlying the surface of the article;
an atomized metal layer on the polymeric layer, the atomized metal layer applied by simultaneous deposition of (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel; and
a transparent top coat layer overlying the atomized metal layer.

2. The multi-layer coating of claim 1 wherein the atomized metal layer comprises from about 50 to about 95 wt % aluminum.

3. The multi-layer coating of claim 1 wherein the article is a metal article and comprises a corrosion inhibiting conversion coating on the surface of the article and the cured polymeric layer is on the conversion coating.

4. The multi-layer coating of claim 3 wherein the corrosion inhibiting conversion coating is selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium.

5. The multi-layer coating of claim 1 wherein the cured polymeric layer comprises one or more of a monofunctional, bi-functional or multi-functional acrylic polymer.

6. The multi-layer coating of claim 5 wherein the acrylic polymer comprises a glycidyl (meth/eth)acrylate.

7. The multi-layer coating of claim 1 wherein the top coat layer comprises one or more of an organic coating, a ceramic coating or an organopolysiloxane coating.

8. The multi-layer coating of claim 1 wherein the top coat layer comprises a second cured polymeric coating which may be the same or different from the cured polymeric layer overlying the corrosion inhibiting conversion coating.

9. The multi-layer coating of claim 1 further comprising a second corrosion inhibiting conversion coating on the atomized metal layer.

10. The multi-layer coating of claim 9 wherein the second corrosion. inhibiting conversion coating is selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium.

11. The multi-layer coating of claim 1 wherein the metal atomized metal layer is deposited by sputtering PVD, CVD or thermal evaporation of (a) and (b).

12. The multi-layer coating of claim 1 wherein the atomized metal layer has a thickness from about 0.5 to about 3 microns.

13-31. (canceled)

32. The multi-layer coating of claim 1 further comprising a cured polymeric primer layer on the surface of the article and overlain by the cured polymeric layer, wherein the cured polymeric primer layer comprises a polymer the same as or different from the cured polymeric layer.

33. (canceled)

34. The multi-layer coating of claim 1 wherein the atomized metal layer comprises from about 50 to about 85 wt % aluminum.

35. A multi-layer coating having a polished effect for the surface of an article, the multi-layer coating comprising:
a cured polymeric layer overlying the surface of the article;
an atomized metal layer on the polymeric layer, the atomized metal layer applied by simultaneous deposition of (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel; and
a transparent top coat layer overlying the atomized metal layer,
wherein the atomized metal layer has a thickness in the range from about 0.5 to about 3 microns and comprises from about 50 to about 95 wt % aluminum.

36. The multi-layer coating of claim 35 wherein the atomized metal layer comprises from about 50 to about 85 wt % aluminum.

37. The multi-layer coating of claim 35 wherein the article is a metal article and comprises a corrosion inhibiting conversion coating on the surface of the article and the cured polymeric layer is on the conversion coating.

38. The multi-layer coating of claim 37 wherein the corrosion inhibiting conversion coating is selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium.

39. The multi-layer coating of claim 35 further comprising a second corrosion inhibiting conversion coating on the metal layer.

40. The multi-layer coating of claim 39 wherein the second corrosion inhibiting conversion coating is selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium.

41. The multi-layer coating of claim 35 wherein the atomized metal layer is deposited by sputtering, PVD, CVD or thermal evaporation of (a) and (b).

42. A multi-layer coating having a polished effect for the surface of a metal article, the multi-layer coating comprising:
a corrosion inhibiting conversion coating on the surface of the metal article;
a cured polymeric layer on the conversion coating;
an atomized metal layer on the polymeric layer, the atomized metal layer applied by simultaneous deposition of (a) aluminum or an aluminum alloy and (b) at least one alloying element, wherein the at least one alloying element comprises one or more of chromium, nickel, titanium, zinc, manganese, iron, cobalt, zirconium, carbon, silicon, molybdenum, vanadium and stainless steel; and
a cured polymeric transparent top coat layer overlying the atomized metal layer,
wherein the atomized metal layer has a thickness in the range from about 0.5 to about 3 microns and comprises from about 50 to about 95 wt % aluminum.

43. The multi-layer coating of claim 42 wherein the corrosion inhibiting conversion coating is selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium.

44. The multi-layer coating of claim 42 further comprising a second corrosion inhibiting conversion coating on the atomized metal layer.

45. The multi-layer coating of claim 44 wherein the second corrosion inhibiting conversion coating is selected from the group consisting of one or more oxide, salt, and combination thereof of a metal selected from the group consisting of aluminum, cadmium, cobalt, cesium, copper, manganese, molybdenum, nickel, silicon, titanium, zinc, and zirconium.

46. The multi-layer coating of claim 42 wherein the atomized metal layer comprises from about 50 to about 85 wt % aluminum.

47. The multi-layer coating of claim 42 wherein the atomized metal layer is deposited by sputtering, PVD, CVD or thermal evaporation of (a) and (b).
